(19) United States
(12) Patent Application Publication
(10) Pub. No.: US 2024/0069335 A1
(43) Pub. Date: Feb. 29, 2024

(54) HEAD-UP DISPLAY

(71) Applicant: KOITO MANUFACTURING CO., LTD., Tokyo (JP)

(72) Inventor: Noriko Sato, Shizuoka (JP)

(73) Assignee: KOITO MANUFACTURING CO., LTD., Tokyo (JP)

(21) Appl. No.: 17/766,463

(22) PCT Filed: Sep. 14, 2020
(86) PCT No.: PCT/JP2020/034668

§ 371 Date: Apr. 4, 2022

(30) Foreign Application Priority Data
Oct. 4, 2019 (JP) 2019-183648
Oct. 4, 2019 (JP) 2019-813649
Nov. 25, 2019 (JP) 2019-212305

(51) Int. Cl. G02B 27/01

(52) U.S. Cl. CPC G02B 27/0101; G02B 2027/0196

(57) ABSTRACT

A head-up display includes an image generation unit configured to emit light for generating predetermined images and a reflection unit configured to reflect the light emitted by the image generation unit so as to radiate the light to a windshield or a combiner. The image generation unit includes a change image generation unit configured to generate a change image that changes in accordance with a situation of a vehicle among the predetermined images, and a fixed image generation unit configured to generate fixed images that are fixed regardless of the situation among the predetermined images.

### TECHNICAL FIELD

The present invention relates to a head-up display.

### BACKGROUND ART

In the future, it is expected that a vehicle traveling in an automatic driving mode and a vehicle traveling in a manual driving mode coexist on a public road.

In a future automatic driving society, it is expected that visual communication between a vehicle and a person becomes more important. For example, it is expected that visual communication between a vehicle and an occupant of the vehicle becomes more important. In this regard, the visual communication between the vehicle and the occupant can be implemented using a head-up display (HUD). The head-up display can achieve so-called augmented reality (AR) by projecting an image or a video on a windshield or a combiner, superimposing the image on a real space through the windshield or the combiner, and enabling the occupant to visually recognize the image.

As an example of the head-up display, Patent Literature 1 discloses a display device including an optical system for displaying a stereoscopic virtual image by using a transparent display medium. The display device projects light onto a windshield or a combiner in a field of view of a driver. A part of the projected light passes through the windshield or the combiner, and the other part is reflected by the windshield or the combiner. The reflected light is directed to eyes of the driver. The driver perceives the reflected light that enters the eyes of the driver as a virtual image that appears to be an image of an object at an opposite side (outside of an automobile) of the windshield or the combiner against a background of a real object that can be seen through the windshield or combiner.

### CITATION LIST

### Patent Literature

Patent Literature 1: JP-A-2018-45103

### SUMMARY OF INVENTION

### Technical Problem

In the existing head-up display, a configuration of expanding a display range of a virtual image (an image) needs to be improved.

An object of the present invention is to provide a head-up display that can expand a display range of an image at low costs.

### Solution to Problem

In order to achieve the above object, according to one aspect of the present invention, there is provided a head-up display.

The head-up display is provided in a vehicle and configured to display predetermined images toward an occupant of the vehicle. The head-up display includes:

an image generation unit configured to emit light for generating the predetermined images; and

a reflection unit configured to reflect the light emitted by the image generation unit so as to radiate the light to a windshield or a combiner.

The image generation unit includes a change image generation unit configured to generate a change image that changes in accordance with a situation of the vehicle among the predetermined images, and a fixed image generation unit configured to generate fixed images that are fixed regardless of the situation among the predetermined images.

According to the above configuration, since the fixed images can be generated by being added to the change image, it is possible to expand an image display range without increasing a size of the high-cost change image generation unit.

In order to achieve the above object, according to another aspect of the present invention, there is provided a head-up display.

The head-up display is provided in a vehicle and configured to display predetermined images toward an occupant of the vehicle. The head-up display includes:

a change image generation unit configured to emit light for generating a change image that changes in accordance with a situation of the vehicle among the predetermined images;

a reflection unit configured to reflect the light emitted by the change image generation unit so as to radiate the light to a windshield or a combiner; and

a fixed image generation unit configured to generate fixed images that are fixed regardless of the situation among the predetermined images.

The fixed image generation unit includes:

a light source,

an optical member that transmits or reflects light emitted from the light source, and

a shield member that is provided at a side opposite to the light source across the optical member and transmits the light corresponding to a shape of the fixed image.

According to the above configuration, since the fixed images can be generated by being added to the change image, it is possible to expand an image display range without increasing a size of the high-cost change image generation unit.

### Advantageous Effects of Invention

According to the present invention, it is possible to provide a head-up display that can expand a display range of an image at low costs.

### BRIEF DESCRIPTION OF RENDERINGS

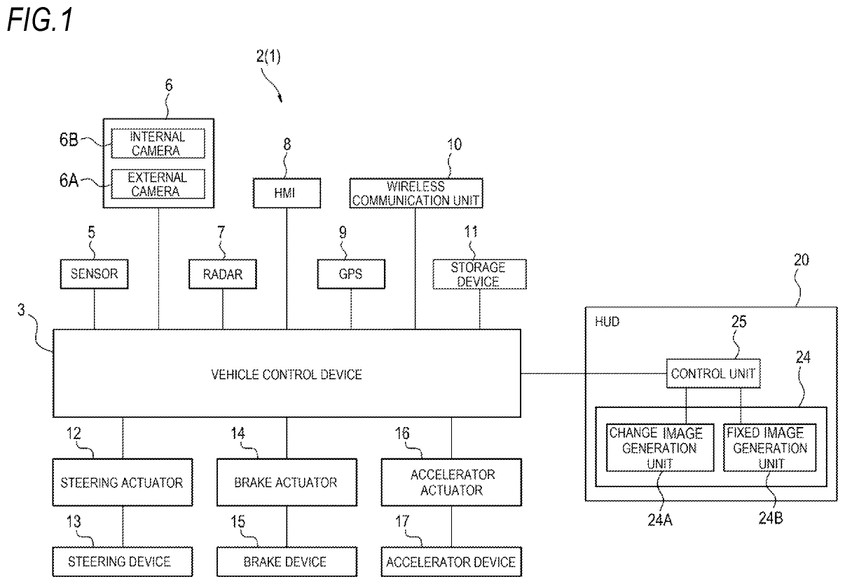

FIG. 1 is a block diagram showing a vehicle system including a head-up display (HUD) according to a first embodiment.

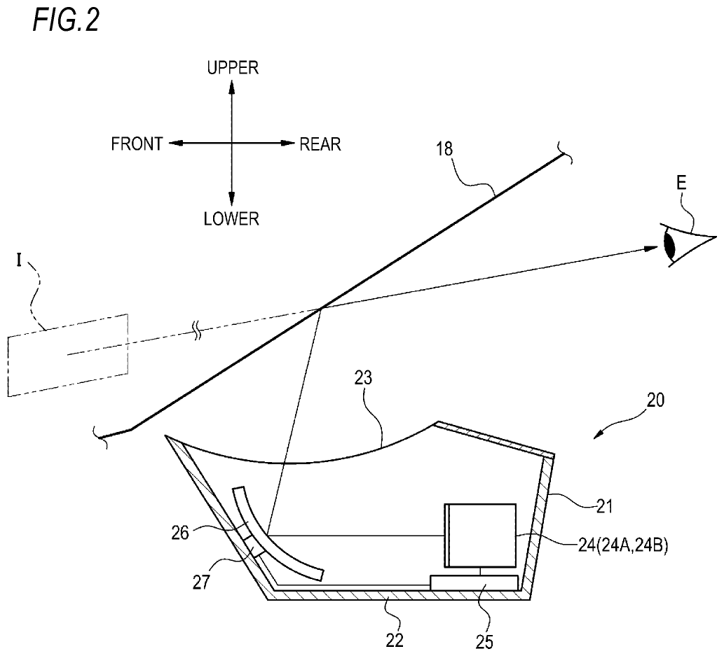

FIG. 2 is a schematic diagram showing a configuration of the HUD.

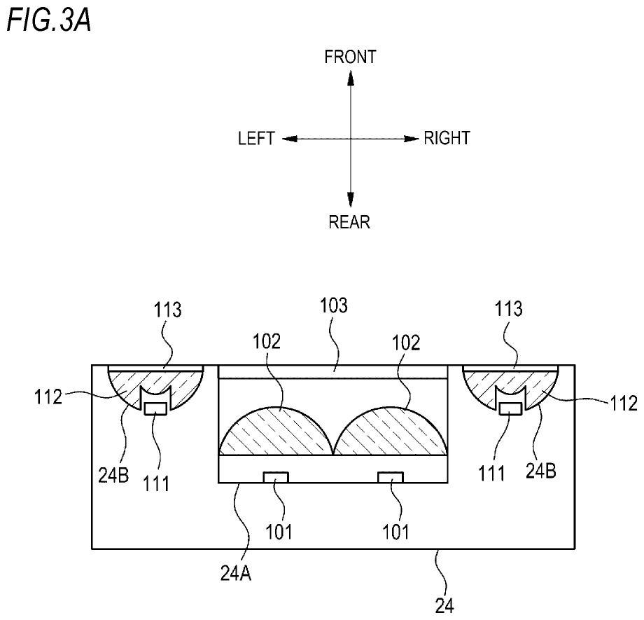

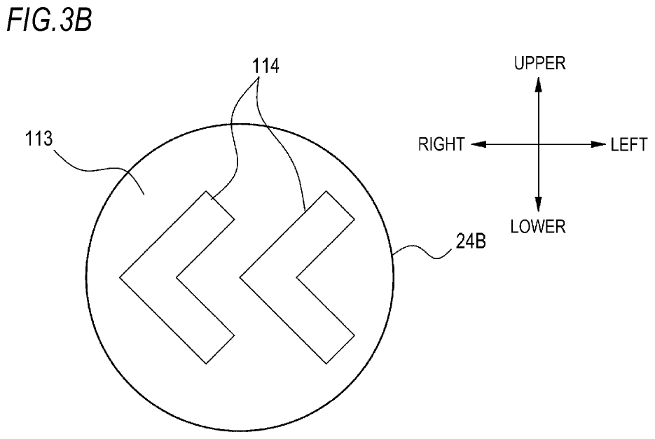

FIG. 3A is a schematic diagram showing a configuration of an image generation unit.

FIG. 3B is a schematic diagram showing a fixed image generation unit constituting the image generation unit in FIG. 3A.

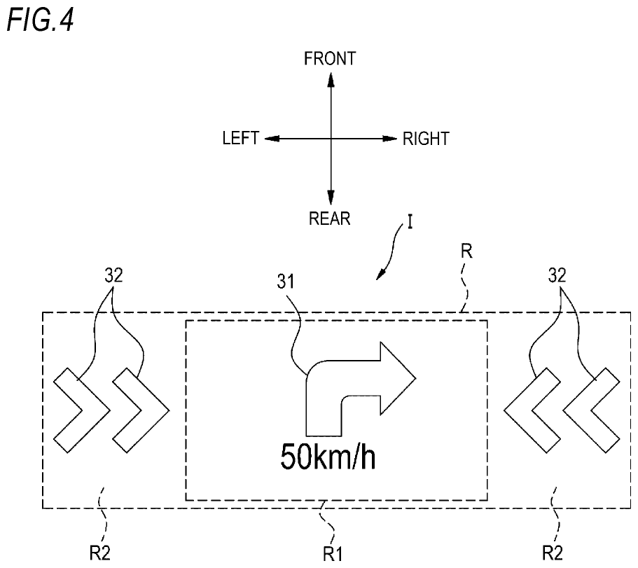

FIG. 4 is a diagram showing an example of a change image and a fixed image that form a virtual image object.

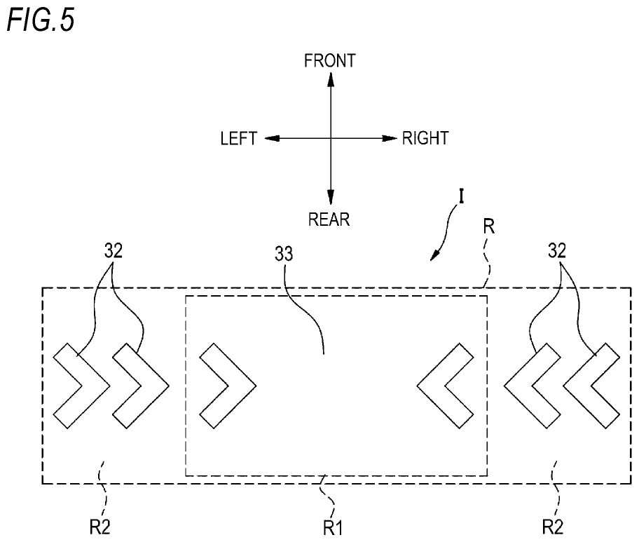

FIG. 5 is a diagram showing another example of a change image and a fixed image that form a virtual image object.

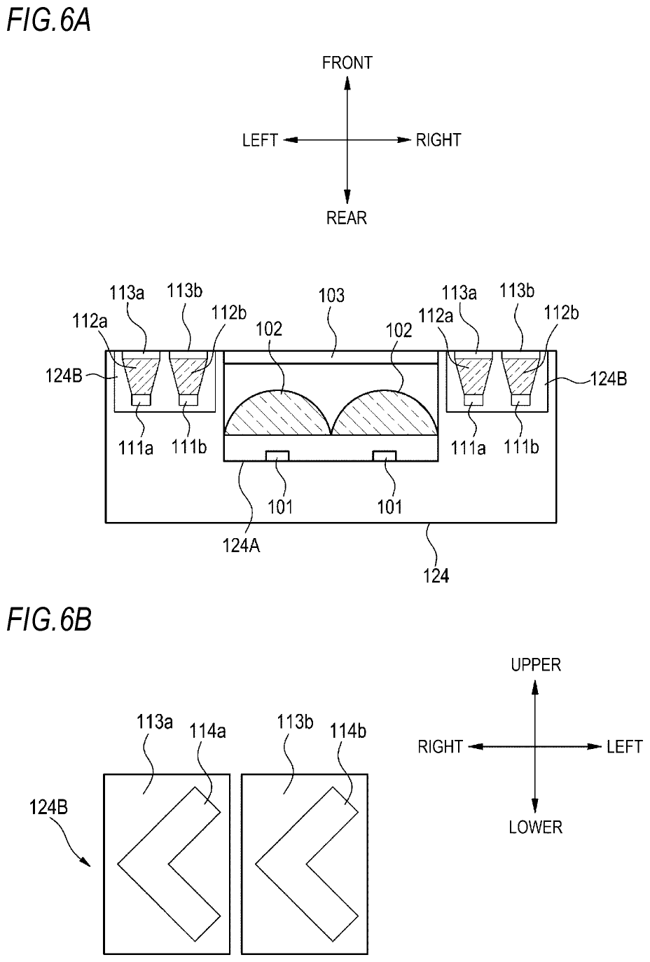

FIG. 6A is a schematic diagram showing a configuration of an image generation unit according to a second embodiment.

FIG. 6B is a schematic diagram showing a fixed image generation unit constituting the image generation unit in FIG. 6A.

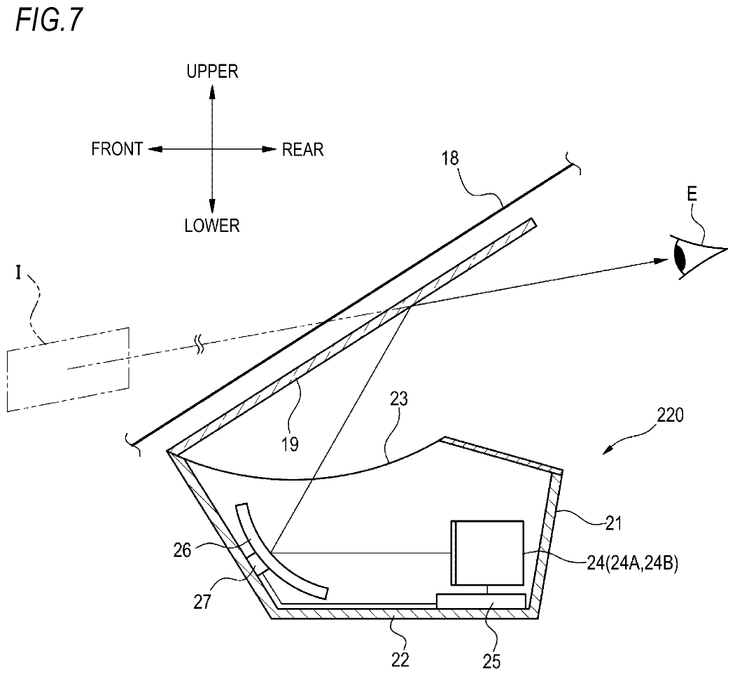

FIG. 7 is a schematic diagram showing an HUD according to a first modification.

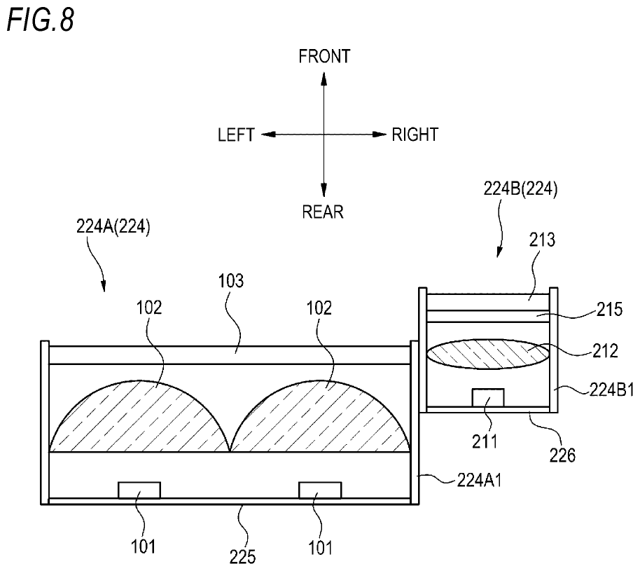

FIG. 8 is a schematic diagram showing a configuration of an image generation unit according to a third embodiment.

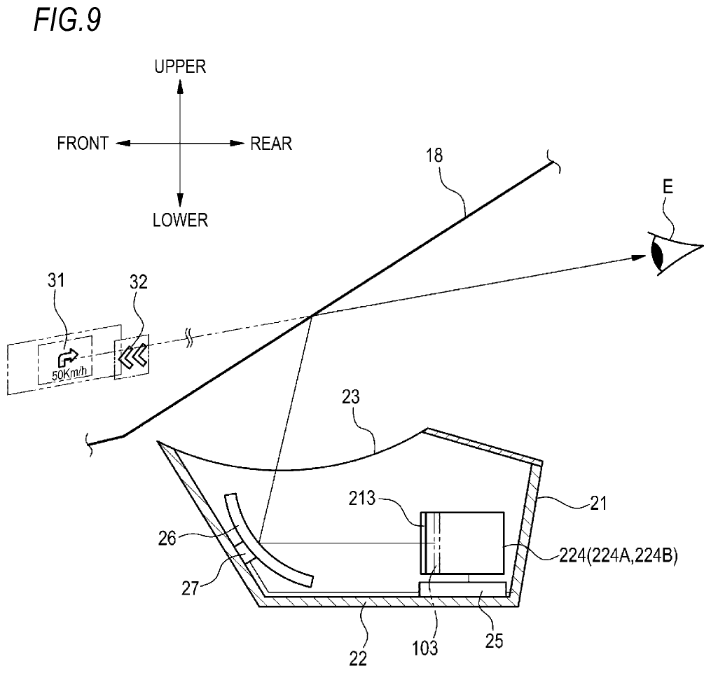

FIG. 9 is a diagram showing a change image and a fixed image that form a virtual image object generated by the image generation unit according to the third embodiment.

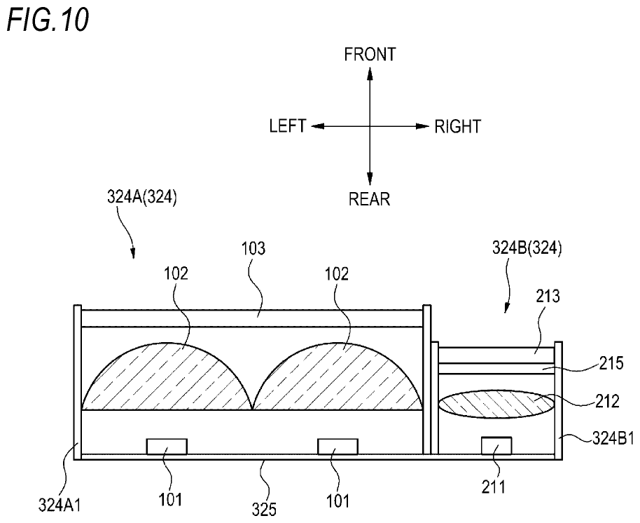

FIG. 10 is a schematic diagram showing a configuration of an image generation unit according to a modification of the third embodiment.

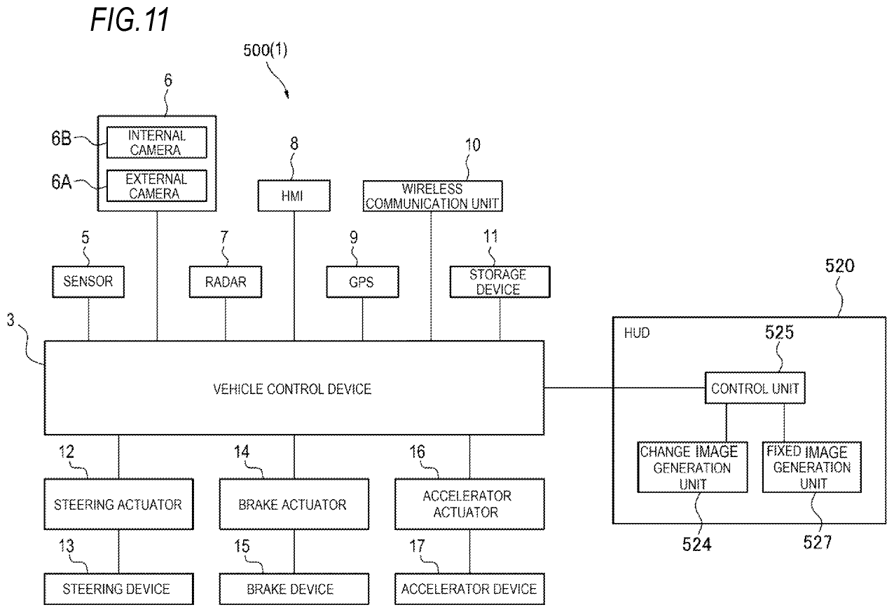

FIG. 11 is a block diagram showing a vehicle system including a head-up display (HUD) according to a fourth embodiment.

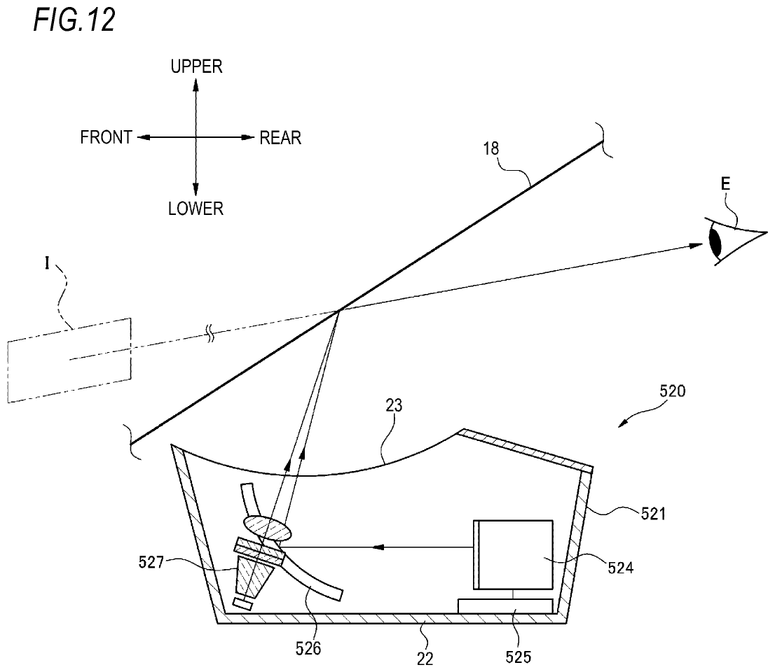

FIG. 12 is a schematic diagram showing a configuration of the HUD shown in FIG. 11.

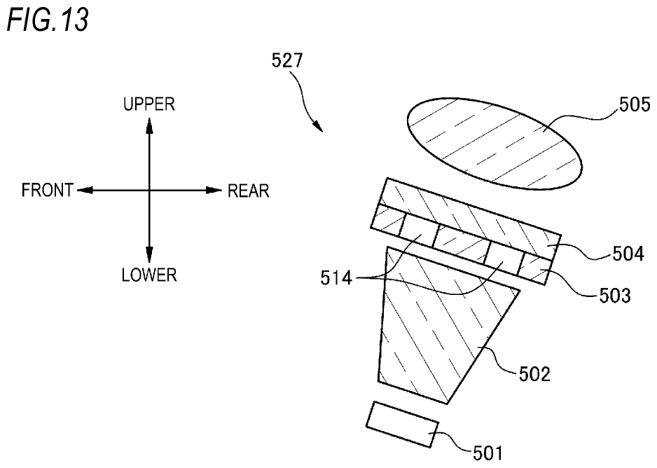

FIG. 13 is a schematic diagram showing a configuration of a fixed image generation unit provided in the HUD shown in FIG. 11.

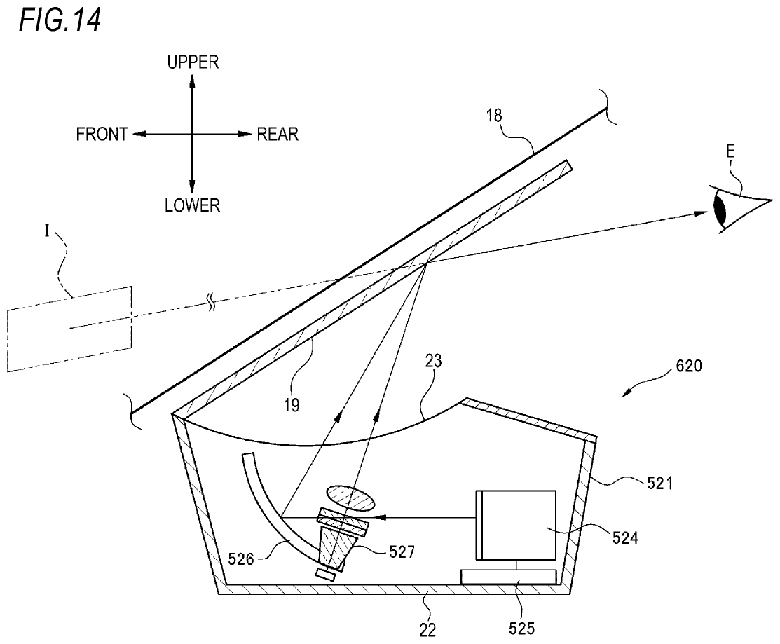

FIG. 14 is a schematic diagram showing an HUD according to a second modification.

### DESCRIPTION OF EMBODIMENTS

Hereinafter, an embodiment of the present invention (hereinafter, referred to as the present embodiment) will be described with reference to the drawings. Dimensions of members shown in the drawings may be different from actual dimensions of the members for the sake of convenience of description.

In the description of the present embodiment, a “left-right direction”, an “upper-lower direction”, and a “front-rear direction” may be appropriately referred to for the convenience of description. These directions are relative directions set for a head-up display (HUD) 20 shown in FIG. 2. Here, the “left-right direction” is a direction including a “left direction” and a “right direction”. The “upper-lower direction” is a direction including an “upper direction” and a “lower direction”. The “front-rear direction” is a direction including a “front direction” and a “rear direction”. Although not shown in FIG. 2, the left-right direction is a direction orthogonal to the upper-lower direction and the front-rear direction.

A vehicle system 2 including the HUD 20 according to the present embodiment will be described below with reference to FIG. 1. FIG. 1 is a block diagram showing the vehicle system 2. A vehicle 1 equipped with the vehicle system 2 is a vehicle (an automobile) that can travel in an automatic driving mode.

As shown in FIG. 1, the vehicle system 2 includes a vehicle control unit 3, a sensor 5, a camera 6, a radar 7, a human machine interface (HMI) 8, a global positioning system (GPS) 9, a wireless communication unit 10, and a storage device 11. In addition, the vehicle system 2 includes a steering actuator 12, a steering device 13, a brake actuator 14, a brake device 15, an accelerator actuator 16, and an accelerator device 17. The vehicle system 2 further includes the HUD 20.

The vehicle control unit 3 controls traveling of the vehicle 1. The vehicle control unit 3 includes, for example, at least one electronic control unit (ECU). The electronic control unit includes a computer system (for example, a system on chip (SoC) or the like) including one or more processors and memories, and an electronic circuit including an active element such as a transistor and a passive element such as a resistor. The processor includes, for example, at least one of a central processing unit (CPU), a micro processing unit (MPU), a graphics processing unit (GPU), and a tensor processing unit (TPU). The CPU may be configured with a plurality of CPU cores. The GPU may be configured with a plurality of GPU cores. The memory includes a read only memory (ROM) and a random access memory (RAM). The ROM may store a vehicle control program. For example, the vehicle control program may include an artificial intelligence (AI) program for automatic driving. The AI program is a program (learned model) constructed by supervised or unsupervised machine learning (in particular, deep learning) using a multi-layer neural network. The RAM may temporarily store a vehicle control program, vehicle control data, and/or surrounding environment information indicating a surrounding environment of the vehicle 1. The processor may be configured to load a program designated from various vehicle control programs stored in the ROM onto the RAM and execute various types of processing in cooperation with the RAM. The computer system may be configured with a non-Von Neumann computer such as an application specific integrated circuit (ASIC) and a field-programmable gate array (FPGA). Further, the computer system may be a combination of a Von Neumann computer and a non-Von Neumann computer.

The sensor 5 includes at least one of an acceleration sensor, a speed sensor, and a gyro sensor. The sensor 5 detects a traveling state of the vehicle 1 and outputs traveling state information to the vehicle control unit 3. The sensor 5 may further include a seating sensor that detects whether a driver is seated in a driver seat, a face orientation sensor that detects the orientation of the face of the driver, an external weather sensor that detects an external weather condition, a human sensor that detects whether there is a person in the vehicle, and the like.

The camera 6 is, for example, a camera including an imaging element such as a charge-coupled device (CCD) and a complementary MOS (CMOS). The camera 6 includes one or more external cameras 6A and an internal camera 6B.

The external camera 6A is configured to acquire image data indicating a surrounding environment of the vehicle 1 and then transmit the image data to the vehicle control unit 3. The vehicle control unit 3 acquires surrounding environment information based on the image data transmitted from the external camera 6A. Here, the surrounding environment information may include information related to an object (a pedestrian, another vehicle, a sign or the like) present outside the vehicle 1. For example, the surrounding environment information may include information related to an attribute of an object present outside the vehicle 1 and information related to a distance or a position of the object relative to the vehicle 1. The external camera 6A may be configured as a monocular camera, or may be configured as a stereo camera.

The internal camera 6B is disposed inside the vehicle 1 and is configured to acquire image data indicating an occupant. The internal camera 6B functions as, for example, an eye tracking camera that tracks a viewpoint E (to be described later in FIG. 2) of the occupant. The internal camera 6B is provided, for example, in the vicinity of a rear-view mirror, inside an instrument panel, or the like.

The radar 7 includes at least one of a millimeter wave radar, a microwave radar, and a laser radar (for example, a LiDAR unit). For example, the LiDAR unit is configured to detect a surrounding environment of the vehicle 1. In particular, the LiDAR unit is configured to acquire 3D mapping data (point cloud data) indicating the surrounding environment of the vehicle 1 and then transmit the 3D mapping data to the vehicle control unit 3. The vehicle control unit 3 specifies the surrounding environment information based on the 3D mapping data transmitted from the LiDAR unit.

The HMI 8 includes an input unit that receives an input operation from a driver, and an output unit that outputs traveling information or the like to the driver. The input unit includes a steering wheel, an accelerator pedal, a brake pedal, a driving mode switch that switches a driving mode of the vehicle 1, and the like. The output unit is a display (excluding the HUD) that displays various kinds of traveling information.

The GPS 9 is configured to acquire current position information of the vehicle 1 and output the acquired current position information to the vehicle control unit 3.

The wireless communication unit 10 receives information (for example, traveling information) related to another vehicle present surrounding the vehicle 1 from the another vehicle and transmits information (for example, traveling information) related to the vehicle 1 to the another vehicle (vehicle-to-vehicle communication). The wireless communication unit 10 is configured to receive infrastructure information from an infrastructure facility such as traffic lights or a sign lamp and transmit traveling information about the vehicle 1 to the infrastructure facility (road-to-vehicle communication). The wireless communication unit 10 is configured to receive information related to a pedestrian from a portable electronic device (a smart phone, a tablet, a wearable device or the like) carried by the pedestrian and transmit own vehicle traveling information of the vehicle 1 to the portable electronic device (pedestrian-vehicle communication). The vehicle 1 may directly communicate with another vehicle, the infrastructure facility, or the portable electronic device in an ad-hoc mode, or may communicate with another vehicle, the infrastructure equipment, or the portable electronic device via an access point. Further, the vehicle 1 may communicate with another vehicle, the infrastructure facility, or the portable electronic device via a communication network (not shown). The communication network includes at least one of the Internet, a local area network (LAN), a wide area network (WAN), and a radio access network (RAN). A radio communication standard is, for example, Wi-Fi (registered trademark), Bluetooth (registered trademark), ZigBee (registered trademark), IPWA, DSRC (registered trademark) or Li-Fi. Further, the vehicle 1 may communicate with another vehicle, the infrastructure facility, or the portable electronic device by using a fifth generation mobile communication system (5G).

The storage device 11 is an external storage device such as a hard disk drive (HDD) and a solid state drive (SSD). The storage device 11 may store two-dimensional or three-dimensional map information and/or a vehicle control program. For example, the three-dimensional map information may be configured with 3D mapping data (point cloud data). The storage device 11 is configured to output the map information and the vehicle control program to the vehicle control unit 3 in response to a request from the vehicle control unit 3. The map information and the vehicle control program may be updated via the wireless communication unit 10 and the communication network.

When the vehicle 1 travels in an automatic driving mode, the vehicle control unit 3 automatically generates at least one of a steering control signal, an accelerator control signal, and a brake control signal based on the traveling state information, the surrounding environment information, the current position information, the map information, and the like. The steering actuator 12 is configured to receive the steering control signal from the vehicle control unit 3 and control the steering device 13 based on the received steering control signal. The brake actuator 14 is configured to receive the brake control signal from the vehicle control unit 3 and control the brake device 15 based on the received brake control signal. The accelerator actuator 16 is configured to receive the accelerator control signal from the vehicle control unit 3 and control the accelerator device 17 based on the received accelerator control signal. In this manner, the vehicle control unit 3 automatically controls the traveling of the vehicle 1 based on the traveling state information, the surrounding environment information, the current position information, the map information, and the like. That is, the traveling of the vehicle 1 is automatically controlled by the vehicle system 2 in the automatic driving mode.

On the other hand, when the vehicle 1 travels in a manual driving mode, the vehicle control unit 3 generates a steering control signal, an accelerator control signal, and a brake control signal in accordance with a manual operation of the driver on an accelerator pedal, a brake pedal, and a steering wheel. In this manner, since the steering control signal, the accelerator control signal, and the brake control signal are generated by a manual operation of the driver in the manual driving mode, the traveling of the vehicle 1 is controlled by the driver.

As described above, the driving modes include the automatic driving mode and the manual driving mode. The automatic driving mode includes, for example, a fully automatic driving mode, an advanced driving support mode, and a driving support mode. In the fully automatic driving mode, the vehicle system 2 automatically performs all kinds of traveling controls including a steering control, a brake control, and an accelerator control, and the driver cannot drive the vehicle 1. In the advanced driving support mode, the vehicle system 2 automatically performs all kinds of traveling controls including a steering control, a brake control, and an accelerator control, and the driver can drive the vehicle 1 but does not drive the vehicle 1. In the driving support mode, the vehicle system 2 automatically performs a part of the traveling controls including a steering control, a brake control, and an accelerator control, and the driver drives the vehicle 1 under the driving support of the vehicle system 2. On the other hand, in the manual driving mode, the vehicle system 2 does not automatically perform the traveling controls, and the driver drives the vehicle 1 without the driving support of the vehicle system 2.

The HUD 20 displays predetermined information (hereinafter, referred to as HUD information) as an image toward an occupant of the vehicle 1 in a manner in which the HUD information is superimposed on a real space outside the vehicle 1 (in particular, a surrounding environment in front of the vehicle 1). The HUD information displayed by the HUD 20 is, for example, vehicle traveling information related to the traveling of the vehicle 1 and/or surrounding environment information related to a surrounding environment of the vehicle 1 (in particular, information related to an object present outside the vehicle 1). The HUD 20 is an AR display that functions as a visual interface between the vehicle 1 and the occupant.

The HUD 20 includes an image generation unit (PGU) 24 and a control unit 25. The image generation unit 24 includes a change image generation unit 24A and a fixed image generation unit 24B.

The image generation unit 24 is configured to emit light for generating predetermined images to be displayed toward an occupant of the vehicle 1. The change image generation unit 24A emits light for generating a change image that changes in accordance with a situation of the vehicle 1 among the predetermined images. The fixed image generation unit 24B emits light for generating fixed images that are fixed regardless of the situation of the vehicle 1 among the predetermined images.

The control unit 25 controls the operation of each unit of the HUD 20. The control unit 25 is connected to the vehicle control unit 3, and controls, for example, operations of the change image generation unit 24A and the fixed image generation unit 24B based on the vehicle traveling information, the surrounding environment information, and the like transmitted from the vehicle control unit 3. Although the vehicle control unit 3 and the control unit 25 are provided as separate bodies in the present embodiment, the vehicle control unit 3 and the control unit 25 may be provided as an integrated body. For example, the vehicle control unit 3 and the control unit 25 may be configured with a single electronic control unit.

### First Embodiment

FIG. 2 is a schematic diagram showing the HUD 20 according to a first embodiment as viewed from a side surface of the vehicle 1. At least a part of the HUD 20 is located inside the vehicle 1. Specifically, the HUD 20 is installed at a predetermined position inside the vehicle 1. For example, the HUD 20 may be disposed inside a dashboard of the vehicle 1.

As shown in FIG. 2, the HUD 20 includes an HUD main body 21. The HUD main body 21 includes a housing 22 and an emission window 23. The emission window 23 is formed of a transparent plate that transmits visible light. The HUD main body 21 includes the image generation unit 24 (the change image generation unit 24A and the fixed image generation unit 24B), the control unit 25, and a concave mirror 26 (an example of a reflection unit) inside the housing 22.

The concave mirror 26 is disposed on an optical path of the light emitted from the image generation unit 24 (the change image generation unit 24A and the fixed image generation unit 24B). The concave mirror 26 is configured to reflect the light emitted from the image generation unit 24 toward the windshield 18 (for example, a front window of the vehicle 1). The concave mirror 26 has a reflecting surface that is curved into a concave shape in order to form a predetermined image, and reflects an image of light that is emitted from the image generation unit 24 and is used to form an image at a predetermined magnification. The concave mirror 26 may include a drive mechanism 27, and may be configured in a manner in which an orientation of the concave mirror 26 can be rotated based on a control signal transmitted from the control unit 25.

The control unit 25 includes a processor such as a central processing unit (CPU) and a memory, and the processor executes a computer program read from the memory to control the operation of the image generation unit 24 (the change image generation unit 24A and the fixed image generation unit 24B). For example, the control unit 25 generates a control signal for controlling the operation of the image generation unit 24 based on the vehicle traveling information, the surrounding environment information, and the like transmitted from the vehicle control unit 3, and transmits the generated control signal to the image generation unit 24. The control unit 25 may control and change the orientation of the concave mirror 26.

The light emitted from the image generation unit 24 (the change image generation unit 24A and the fixed image generation unit 24B) is reflected by the concave mirror 26 and emitted from the emission window 23 of the HUD main body 21. The light emitted from the emission window 23 of the HUD main body 21 is radiated to the windshield 18. A part of the light radiated from the emission window 23 to the windshield 18 is reflected toward the viewpoint E of an occupant. As a result, the occupant recognizes the light emitted from the HUD main body 21 as a virtual image (a predetermined image) formed at a predetermined distance in front of the windshield 18. In this manner, an image displayed by the HUD 20 is superimposed on a real space in front of the vehicle 1 through the windshield 18. As a result, the occupant can visually recognize a virtual image object I formed by the predetermined image in a manner in which the virtual image object I floats on a road located outside the vehicle.

Here, the viewpoint E of the occupant may be either a viewpoint of a left eye or a viewpoint of a right eye of the occupant. Alternatively, the viewpoint E may be defined as a midpoint of a line segment that connects the viewpoint of the left eye and the viewpoint of the right eye. The position of the viewpoint E of the occupant is specified based on, for example, image data acquired by the internal camera 6B. The position of the viewpoint E of the occupant may be updated at a predetermined cycle, or may be determined only once at the time of starting the vehicle 1.

When a 2D image (a planar image) is formed as the virtual image object I, a predetermined image is projected as a virtual image at a determined single distance. When a 3D image (a stereoscopic image) is formed as the virtual image object I, a plurality of predetermined images that are the same as one another or different from one another are projected as virtual images at different distances. A distance of the virtual image object I (a distance from the viewpoint E of the occupant to the virtual image) can be appropriately adjusted by adjusting a distance from the image generation unit 24 to the viewpoint E of the occupant (for example, adjusting a distance between the image generation unit 24 and the concave mirror 26).

FIGS. 3A and 3B are schematic diagrams showing a configuration of the image generation unit 24 according to the first embodiment. FIG. 3A is a schematic diagram showing the image generation unit 24 (the change image generation unit 24A and the fixed image generation unit 24B) as viewed from above. FIG. 3B is a schematic front view showing the fixed image generation unit 24B.

As shown in FIG. 3A, the change image generation unit 24A includes a light source 101, an optical member 102 disposed at a front side of the light source 101, and a display device 103 disposed at a front side of the optical member 102. The light source 101 is, for example, a laser light source or an LED light source. The laser light source is, for example, an RGB laser light source configured to emit red laser light, green light laser light, and blue laser light. The optical member 102 may include at least one of a prism, a lens, a diffusion plate, a magnifying glass, and the like. For example, the optical member 102 is formed of a plano-convex lens in the present example. The optical member 102 is configured to transmit or reflect light emitted from the light source 101 and emit the light toward the display device 103. The display device 103 is a liquid crystal display, a digital mirror device (DMD), or the like. A drawing method of the change image generation unit 24A may be a raster scan method, a digital light processing (DLP) method, or a liquid crystal on silicon (LCOS) method. When the DLP method or the LCOS method is adopted, the light source 101 of the change image generation unit 24A may be an LED light source. When a liquid crystal display system is adopted, the light source 101 of the change image generation unit 24A may be a white LED light source.

The fixed image generation unit 24B includes a light source 111, an optical member 112 disposed at a front side of the light source 111, and a shield member 113 disposed at a front side of the optical member 112 (closer to the concave mirror 26 than the optical member 112). Similar to the light source 101, the light source 111 is, for example, a laser light source or an LED light source. The optical member 112 may include at least one of a reflector, a prism, a lens, a diffusion plate, a magnifying glass, and the like. In the present example, the optical member 112 is configured with, for example, a lens formed into a predetermined shape so as to increase utilization efficiency of the light emitted from the light source 111. The optical member 112 is configured to transmit or reflect the light emitted from the light source 111 and uniformly emit the light toward the shield member 113. The shield member 113 includes, for example, a synthetic resin film and a light shield film (shade) formed on at least one surface of the synthetic resin film. For example, a light diffusing agent is added to the synthetic resin film constituting a part of the shield member 113. As shown in FIG. 3B, the shield member 113 is provided with a notch 114 as a light transmitting portion that transmits the light of the light source 111 so as to correspond to a shape of a fixed image. The shield member 113 is configured to radiate the light of the light source 111 to a front side through the notch 114. The fixed image generation unit 24B is disposed at each of the left and right sides of the change image generation unit 24A. A shape of the shield member 113 in a front view is not limited to a circular shape as in the present embodiment. In addition, the position of the fixed image generation unit 24B is not limited to the left and right sides of the change image generation unit 24A, and for example, the fixed image generation unit 24B may be disposed at any one of an upper side and a lower side of the change image generation unit 24A. Instead of adding the light diffusing agent to the synthetic resin film, a synthetic resin film may be provided rearward (at the optical member 112 side) of the light shield film (shade), and a fine step for light diffusion may be formed on a front surface of the synthetic resin film.

FIG. 4 is a schematic diagram showing an example of a change image and a fixed image that form the virtual image object I.

In FIG. 4, a change image 31 is an image generated by light emitted from the change image generation unit 24A. Fixed images 32 are images generated by light emitted from the fixed image generation unit 24B. In front of the vehicle 1, a position at which the change image 31 is recognized and a position at which the fixed image 32 is recognized are substantially the same position. That is, a distance from the windshield 18 to the change image 31 and a distance from the windshield 18 to the fixed image 32 are substantially the same distance.

The fixed images 32 are displayed around the change image 31 in a manner of being aligned with the change image 31. In the present example, the fixed images 32 are displayed at left and right sides of the change image 31 as viewed from an occupant of the vehicle 1. The change image 31 is an image that changes in accordance with a situation of the vehicle 1. In the present example, a travel path image notifying that the vehicle 1 turns right ahead and a speed image notifying that a current traveling speed is 50 km/h are displayed as the change image 31. The fixed images 32 are images fixed regardless of the situation of the vehicle 1. In the present example, attention attracting images (mountain parenthesis patterns) for attracting attention of an occupant of the vehicle 1 are displayed as the fixed images 32. The attention attracting image is an image generated only when necessary, and may be displayed for the purpose of notifying the presence of a pedestrian, notifying that a speed is too high, and the like. A range R of an image that is visually recognized as the virtual image object I is an image range obtained by adding a display range R1 of the change image 31 formed by the light emitted from the change image generation unit 24A and display ranges R2 of the fixed images 32 formed by the light emitted from the fixed image generation unit 24B.

A plurality of types of patterns of the notch 114 provided in the shield member 113 of the fixed image generation unit 24B for forming fixed images may be prepared. For example, the fixed image may be a humanoid mark imitating a shape of a child for the purpose of attracting attention to a pop out child. The fixed image generation unit 24B may include, for example, a drive mechanism (not shown), and may be configured to switch the patterns of the notch 114 in the shield member 113 based on a control signal transmitted from the control unit 25.

Image distortions caused by reflection of the concave mirror 26 may be different in the fixed images 32 displayed around the change image 31 depending on display positions of the fixed images 32. Therefore, it is preferable that the control unit 25 adjusts the pattern of the notch 114 provided in the shield member 113 so as to change a distortion degree of the fixed image 32 generated by the fixed image generation unit 24B in advance in accordance with a display position at which the fixed image 32 is displayed. In addition, it is preferable that the control unit 25 controls an image generated by the change image generation unit 24A so that a display pattern of the change image 31 becomes an appropriate display pattern without distortion.

FIG. 5 is a schematic diagram showing another example of a change image and a fixed image that form the virtual image object I.

As shown in FIG. 5, information displayed by a change image 33 and information displayed by the fixed images 32 may be associated with each other. In the present example, both the change image 33 and the fixed images 32 are displayed in the same pattern (a mountain parenthesis pattern) as an attention attracting image for attracting attention to the traveling of the vehicle 1. The fixed images 32 are respectively displayed side by side to the change image 31 at the left and right sides of the change image 31. Although the change image 33 is displayed as a fixed mountain parenthesis pattern in the present example, for example, the change image 33 may be displayed as an image that sequentially changes according to a situation of the vehicle 1 in association with the fixed images 32. For example, a humanoid mark of a child may be displayed as a fixed image, and a change image that recalls popping out of the child may be displayed in association with the humanoid mark.

As described above, the HUD 20 according to the present embodiment includes the image generation unit 24 that emits light for generating the virtual image object I (a predetermined image), and the concave mirror 26 (an example of a reflection unit) that reflects the light emitted by the image generation unit 24 so as to radiate the light to the windshield 18. The image generation unit 24 includes the change image generation unit 24A configured to generate the change image 31 that changes in accordance with a situation of the vehicle 1 among the virtual image object I, and the fixed image generation unit 24B configured to generate the fixed images 32 that are fixed regardless of the situation among the virtual image object I. According to this configuration, the virtual image object I can be formed by adding the fixed images 32 generated by the fixed image generation unit 24B to the change image 31 generated by the change image generation unit 24A. Therefore, a display range of the virtual image object I (an example of a predetermined image) can be expanded without increasing a size of the high-cost change image generation unit 24A.

According to the HUD 20, contents of information displayed by the change image 33 and the fixed images 32 may be associated with each other as shown in FIG. 5. Accordingly, various kinds of information can be provided to an occupant by the cooperation of the change image 33 and the fixed image 32.

According to the HUD 20, the fixed image generation unit 24B includes the light source 111, the optical member 112, and the shield member 113. As a result, the fixed image generation unit 24B can be configured with a simple configuration, and costs can be reduced.

Although the light emitted from the image generation unit 24 is directly radiated to the concave mirror 26 in the embodiment described above, the present invention is not limited to this example. A reflection unit (for example, a plane mirror) different from the concave mirror 26 may be disposed between the image generation unit 24 and the concave mirror 26, and the light emitted from the image generation unit 24 may be reflected by the plane mirror and then radiated to the concave mirror 26. In the case of adopting a configuration in which a plane mirror is disposed on an optical path between the image generation unit 24 and the concave mirror 26 in this manner, for example, a configuration may be adopted in which the light emitted from the change image generation unit 24A is radiated to the concave mirror 26 via the plane mirror, that is, the light is reflected twice between the change image generation unit 24A and the windshield 18, and the light emitted from the fixed image generation unit 24B is directly radiated to the concave mirror 26 without passing through the plane mirror, that is, the light is reflected once between the fixed image generation unit 24B and the windshield 18. Accordingly, it is possible to reduce the costs as much as possible while adopting the plane mirror as an additional configuration.

### Second Embodiment

FIGS. 6A and 6B are schematic diagrams showing a configuration of an image generation unit 124 according to a second embodiment. FIG. 6A is a schematic diagram showing the image generation unit 124 (a change image generation unit 124A and a fixed image generation unit 124B) as viewed from above. FIG. 6B is a schematic front view showing the fixed image generation unit 124B.

As shown in FIG. 6A, the change image generation unit 124A includes the light source 101, the optical member 102, and the display device 103. Since the change image generation unit 124A according to the second embodiment has the same configuration as the change image generation unit 24A in the HUD 20 according to the first embodiment, detailed description thereof will be omitted.

The fixed image generation unit 124B includes a plurality of (two in this example) light sources 111a and 111b arranged in parallel, optical members 112a and 112b respectively arranged in front of the light sources 111a and 111b, and shield members 113a and 113b respectively arranged in front of the optical members 112a and 112b. The light sources 111a and 111b, the optical members 112a and 112b, and the shield members 113a and 113b respectively have the same configurations as the light source 111, the optical member 112, and the shield member 113 in the fixed image generation unit 24B according to the first embodiment. The light sources 111a and 111b are mounted on, for example, a single substrate (not shown). For example, the optical members 112a and 112b are configured with lenses formed into a predetermined shape capable of increasing utilization efficiency of light from the light sources 111a and 111b and uniformly emitting light toward the shield members 113a and 113b. Each of the shield members 113a and 113b includes, for example, a synthetic resin film added with a light diffusing agent, and a light shield film (shade) formed on at least one surface of the synthetic resin film. As shown in FIG. 6B, notches 114a and 114b are formed in the shield members 113a and 113b so as to correspond to shapes of the fixed images 32. The fixed image generation unit 124B is disposed at each of the left and right sides of the change image generation unit 124A. The position of the fixed image generation unit 124B may be arranged, for example, at an upper side or a lower side of the change image generation unit 124A.

In the image generation unit 124, for example, when the change image and the fixed image that form the virtual image object I are the change image 33 and the fixed image 32 shown in FIG. 5, the virtual image object I is displayed as follows. For example, the fixed image generation unit 124B sequentially turns on the light sources 111a and 111b when generating the fixed images 32. The change image generation unit 124A generates the change image 33 in association with the turning on of the light sources 111a and 111b by the fixed image generation unit 124B. As a result, the virtual image object I in FIG. 5 is turned on and displayed in such a manner that, for example, the mountain parenthesis patterns move in order from left and right ends toward the center. The turn-on timing of the light sources 111a and 111b for generating the fixed images 32 and contents of information displayed in the change image 33 can be changed as appropriate.

As described above, according to the image generation unit 124 in the second embodiment, it is possible to generate the fixed images 32 by individually turning on and off the plurality of light sources 111a and 111b that are arranged in parallel. Therefore, the fixed images 32 having a good appearance can be displayed as the virtual image object I. Although the plurality of light sources 111a and 111b for generating the fixed images 32 are arranged in parallel in the left-right direction in the present example, the plurality of light sources for generating the fixed images may be arranged in parallel in the upper-lower direction. In this case, marks included in the fixed images are displayed in parallel in the upper-lower direction.

Although the light source 101 of the change image generation unit 124A and the light sources 111a and 111b of the fixed image generation unit 124B are disposed at different positions in the front-rear direction of the vehicle 1 in the second embodiment described above, the present invention is not limited to this example. The light source 101 and the light sources 111a and 111b may be disposed at substantially the same position in the front-rear direction, or the light source 101 and the light sources 111a and 111b may be mounted on a single substrate. Accordingly, for example, it is easy to perform a control in a case where the change image generation unit 124A generates the change image 33 in association with the turning on of the light sources 111a and 111b by the fixed image generation unit 124B.

### First Modification

FIG. 7 is a schematic diagram showing a configuration of an HUD 220 according to a first modification.

As shown in FIG. 7, the HUD 220 according to the first modification includes a HUD main body 21 and a combiner 19. The combiner 19 is provided inside the windshield 18 as a structure separate from the windshield 18. The combiner 19 is, for example, a transparent plastic disk, and light reflected by the concave mirror 26 is radiated to the combiner 19 instead of the windshield 18. Accordingly, a part of the light radiated from the HUD main body 21 to the combiner 19 is reflected toward the viewpoint E of an occupant in a similar manner to the case where light is radiated to the windshield 18. As a result, the occupant can recognize the emitted light (a predetermined image) from the HUD main body 21 as the virtual image object I formed at a front side away from the combiner 19 (and the windshield 18) by a predetermined distance.

In the case where the HUD 220 includes the combiner 19 as described above, the same effects as those of the HUD 20 described above can be achieved.

### Third Embodiment

FIG. 8 is a schematic diagram showing a configuration of an image generation unit 224 according to a third embodiment.

As shown in FIG. 8, the image generation unit 224 according to the third embodiment includes a change image generation unit 224A and a fixed image generation unit 224B. The change image generation unit 224A includes a plurality of light sources 101 and 101, a plurality of optical members 102 and 102 arranged corresponding to the light sources 101 and 101, and the display device 103. The light sources 101 and 101 are mounted on, for example, a single substrate 225. Since other configurations of the change image generation unit 224A according to the third embodiment are the same as those of the change image generation unit 24A in the HUD 20 according to the first embodiment, detailed description thereof will be omitted.

The fixed image generation unit 224B includes a light source 211, an optical member 212 disposed at a front side of the light source 211, and a shield member 213 disposed at a front side of the optical member 212. The light source 211 is mounted on, for example, a substrate 226 different from the substrate 225. The optical member 212 is configured with, for example, a lens formed into a predetermined shape capable of increasing utilization efficiency of light emitted from the light source 211 and uniformly emitting the light toward the shield member 213. Although a biconvex lens is shown as an example of the optical member 212 in the example of FIG. 8, the present invention is not limited to this example. For example, a Fresnel lens may be used as the lens used for the optical member 212. As compared with a case where a plano-convex lens, a biconvex lens, or the like is used, it is possible to achieve a reduction in the thickness of the optical member 212 by using a Fresnel lens in which a normal lens is divided into concentric regions and a thickness is reduced. The optical member 212 may use a vertical cylindrical lens and a horizontal cylindrical lens in combination. Alternatively, the vertical cylindrical lens and the horizontal cylindrical lens may be formed on an emission surface and an incident surface of a single lens. When a cylindrical lens is used, the cylindrical lens may be formed as a so-called linear Fresnel lens having a Fresnel shape.

A light diffusion sheet 215 made of, for example, a synthetic resin film added with a light diffusion agent is attached to a surface of the shield member 213 at the optical member 212 side. Similar to the shield member 113 shown in FIG. 3B, the shield member 213 is provided with a notch corresponding to the shape of the fixed image 32. Although the fixed image generation unit 224B is provided only at the left side of the change image generation unit 224A in FIG. 8, the fixed image generation unit 224B may be disposed at each of the left and right sides of the change image generation unit 224A.

A housing 224B1 that accommodates each member of the fixed image generation section 224B is disposed in a manner of coming into contact with a right side of a housing 224A1 that accommodates each member of the change image generation section 224A. The housing 224B1 of the fixed image generation section 224B is disposed such that a front end of the housing 224B1 is located in front of a front end of the housing 224A1 of the change image generation section 224A in the front-rear direction of the vehicle 1. That is, the shield member 213 of the fixed image generation unit 224B is disposed in front of the display device 103 of the change image generation unit 224A.

As described above, according to the configuration of the image generation unit 224 in the third embodiment, a surface of the fixed image generation unit 224B for generating the fixed image 32 is disposed in front of a surface of the change image generation unit 224A for generating the change image 31. Accordingly, an optical path length of light between the concave mirror 26 and the surface of the fixed image generation unit 224B for generating the fixed image 32 is shorter than an optical path length of light between the concave mirror 26 and the surface of the change image generation unit 224A for generating the change image 31, as shown in FIG. 9. Therefore, a distance between the fixed image 32 and the viewpoint E of an occupant is shorter than a distance between the change image 31 constituting the virtual image object and the viewpoint E of the occupant. In this manner, the fixed image 32 is displayed at a position closer to the viewpoint E of the occupant than the change image 31, so that the fixed image 32 can be made conspicuous, and the occupant can easily notice the fixed image 32.

Although the shield member 213 of the change image generation unit 224A is disposed in front of the display device 103 of the change image generation unit 224A in the third embodiment described above, the present invention is not limited to this example. For example, the shield member 213 of the fixed image generation unit 324B may be disposed in the rear of the display device 103 of the change image generation unit 324A in the front-rear direction of the vehicle 1, as shown in FIG. 10. Specifically, the housing 324B1 of the fixed image generation section 324B is disposed in a manner of coming into contact with a right side of the housing 324A1 of the change image generation section 324A, and is disposed such that a front end of the housing 324B1 is located in the rear of a front end of the housing 324A1. In this case, the light sources 101 and 101 of the change image generation unit 324A and the light source 211 of the fixed image generation unit 324B may be mounted on a single substrate 325. Since the light sources 101 and 101 and the light source 211 are mounted on the single substrate 325, mountability of the light sources can be improved, and the costs of the image generation unit 324 can be reduced.

According to the configuration of the image generation unit 324 shown in FIG. 10, a surface of the change image generation unit 324A for generating the change image 31 is disposed in front of a surface of the fixed image generation unit 324B for generating the fixed image 32. Accordingly, the change image 31 can be displayed at a position closer to the viewpoint E of an occupant than the fixed image 32. In this manner, a distance (an optical path length) between the change image generation unit and the concave mirror 26 is different from a distance (an optical path length) between the fixed image generation unit and the concave mirror 26, so that one of the change image 31 and the fixed image 32 can be made to attract more attention of the occupant than the other one.

### Fourth Embodiment

A vehicle system 500 including an HUD 520 according to a fourth embodiment will be described below with reference to FIG. 11. FIG. 11 is a block diagram showing the vehicle system 500. The same or corresponding components as those of the vehicle system 2 according to the first embodiment will not be repeatedly described.

As shown in FIG. 11, the HUD 520 according to the fourth embodiment includes a change image generation unit 524, a fixed image generation unit 527, and a control unit 525. The change image generation unit 524 emits light for generating a change image that changes in accordance with a situation of the vehicle 1 among predetermined images displayed toward an occupant of the vehicle 1. The fixed image generation unit 527 emits light for generating fixed images that are fixed regardless of the situation of the vehicle 1 among the predetermined images displayed toward the occupant of the vehicle 1.

The control unit 525 controls the operation of each unit of the HUD 520. The control unit 525 is connected to the vehicle control unit 3, and controls operations of the change image generation unit 524, the fixed image generation unit 527, and the like based on the vehicle traveling information, the surrounding environment information, and the like transmitted from the vehicle control unit 3. Although the vehicle control unit 3 and the control unit 525 are provided as separate bodies in the present embodiment, the vehicle control unit 3 and the control unit 525 may be provided as an integrated body. For example, the vehicle control unit 3 and the control unit 525 may be configured with a single electronic control unit.

As shown in FIG. 12, a HUD main body 521 of the HUD 520 includes the change image generation unit 524, a concave mirror 526 (an example of a reflection unit), the fixed image generation unit 527, and the control unit 525 inside the housing 22. The fixed image generation unit 527 is attached to the concave mirror 526. For example, one fixed image generation unit 527 is attached to each of both side portions of the concave mirror 526 in a manner of sandwiching the concave mirror 526 in the left-right direction of the vehicle 1.

The concave mirror 526 is disposed on an optical path of light emitted from the change image generation unit 524. The concave mirror 526 is configured to reflect the light emitted from the change image generation unit 524 toward the windshield 18 (for example, a front window of the vehicle 1).

The control unit 525 includes a processor such as a CPU and a memory, and the processor executes a computer program read from the memory to control operations of the change image generation unit 524 and the fixed image generation unit 527. For example, the control unit 525 generates a control signal for controlling the operation of the change image generation unit 524 based on the vehicle traveling information, the surrounding environment information, and the like transmitted from the vehicle control unit 3, and transmits the generated control signal to the change image generation unit 524. The control unit 525 generates a control signal for controlling the operation of the fixed image generation unit 527 based on the vehicle traveling information, the surrounding environment information, and the like transmitted from the vehicle control unit 3, and transmits the generated control signal to the fixed image generation unit 527. When an orientation of the concave mirror 526 is changed by the control unit 525, an orientation of the fixed image generation unit 527 attached to the concave mirror 526 may also be changed by the control unit 525. The orientation of the fixed image generation unit 527 may be individually changed by the control unit 525. The orientation of the fixed image generation unit 527 is adjusted so as to control an emission angle of light emitted from the fixed image generation unit 527 in a manner in which a fixed image formed by the light emitted from the fixed image generation unit 527 is displayed at a predetermined position relative to a change image formed by light emitted from the change image generation unit 524.

The light emitted from the change image generation unit 524 (hereinafter, also referred to as change light) is reflected by the concave mirror 526 and is emitted from the emission window 23 of the HUD main body 521. The change light emitted from the emission window 23 of the HUD main body 521 is radiated to the windshield 18. A part of the change light radiated from the emission window 23 to the windshield 18 is reflected toward the viewpoint E of an occupant. The light emitted from the fixed image generation unit 527 (hereinafter, also referred to as fixed light) is emitted from the emission window 23 of the HUD main body 521. The fixed light emitted from the emission window 23 of the HUD main body 521 is radiated to the windshield 18. A part of the fixed light radiated from the emission window 23 to the windshield 18 is reflected toward the viewpoint E of an occupant. As a result, the occupant recognizes the light (including the change light and the fixed light) emitted from the HUD main body 521 as a virtual image (a predetermined image) formed at a predetermined distance in front of the windshield 18. In this manner, an image displayed by the HUD 520 is superimposed on a real space in front of the vehicle 1 through the windshield 18. As a result, the occupant can visually recognize the virtual image object I formed by the predetermined image in a manner in which the virtual image object I floats on a road located outside the vehicle.

A distance of the virtual image object I (a distance from the viewpoint E of an occupant to the virtual image) can be appropriately adjusted by adjusting a distance from the change image generation unit 524 and the fixed image generation unit 527 to the viewpoint E of the occupant. For example, a distance from the viewpoint E of the occupant to the change image can be adjusted by adjusting a distance between the change image generation unit 524 and the concave mirror 526. For example, a distance from the viewpoint E of the occupant to the fixed image can be adjusted by adjusting a distance between the fixed image generation unit 527 and the windshield 18.

FIG. 13 is a schematic diagram showing a configuration of the fixed image generation unit 527.

As shown in FIG. 13, the fixed image generation unit 527 includes a light source 501, an optical member 502 disposed diagonally above the light source 501, a shield member 503 disposed diagonally above the optical member 502 (at a side opposite to the light source 501 across the optical member 502), a diffusion sheet 504 disposed diagonally above the shield member 503, and a lens 505 disposed diagonally above the diffusion sheet 504.

The light source 501 is, for example, a laser light source or an LED light source. The laser light source is, for example, an RGB laser light source configured to emit red laser light, green light laser light, and blue laser light.

The optical member 502 may include at least one of a prism, a lens, a reflector, a diffusion plate, a magnifying glass, and the like. In the present example, the optical member 502 is configured with, for example, a lens formed into a predetermined shape so as to increase utilization efficiency of light emitted from the light source 501. The optical member 502 is configured to transmit or reflect the light emitted from the light source 501 and uniformly emit the light toward the shield member 503.

The shield member 503 includes, for example, a synthetic resin film and a light shield film (shade) formed on at least one surface of the synthetic resin film. A notch 514 is formed in the shield member 503 so as to correspond to a shape of a fixed image. The notch 514 has a mountain parenthesis pattern in a similar manner to the notch 114 of the shield member 113 according to the first embodiment (FIG. 3B). The shield member 503 is configured to emit light of the light source 501 toward the lens 505 through the notch 514. That is, the shield member 503 transmits the light of the light source 501 corresponding to the shape of the fixed image. The shield member 503 is detachably provided in the fixed image generation unit 527. A shape of the shield member 503 in a front view is not limited to a circular shape as shown in FIG. 3B, and may be, for example, a rectangular shape in a front view. A pattern of the notch 514 provided in the shield member 503 is not limited to the mountain parenthesis pattern shown in FIG. 3B.

The diffusion sheet 504 is, for example, a film added with a light diffusing agent for diffusing light. The diffusion sheet 504 is configured to uniformly send light emitted from the notch 514 of the shield member 503 toward the lens 505. Instead of adding the light diffusing agent to the diffusion sheet 504, a fine step for light diffusion may be formed on a surface of the diffusion sheet 504 facing the lens 505.

The lens 505 is a lens for adjusting an optical path length of the light emitted from the fixed image generation unit 527. That is, the lens 505 is used to adjust a focus point of light for generating a fixed image and appropriately form the fixed image as a part of the virtual image object I.

Although not shown, the change image generation unit 524 includes a light source, an optical member disposed at a front side of the light source, and a display device disposed at a front side of the optical member. Similar to the light source 501, the light source is, for example, a laser light source or an LED light source. Similar to the optical member 502, the optical member may include at least one of a prism, a lens, a reflector, a diffusion plate, a magnifying glass, and the like. The optical member is configured to transmit or reflect light emitted from the light source and emit the light toward the display device.

Similar to the first embodiment, the change image 31 shown in FIG. 4 is also generated by light emitted from the change image generation unit 524 in the fourth embodiment. In addition, the fixed images 32 shown in FIG. 4 are generated by light emitted from the fixed image generation unit 527.

A plurality of types of patterns of the notch 514 provided in the shield member 503 of the fixed image generation unit 527 for forming fixed images may be prepared. The fixed image generation unit 527 may include a drive mechanism (not shown), and may be configured to switch the patterns of the notch 514 in the shield member 503 based on a control signal transmitted from the control unit 525.

Similar to the first embodiment, information displayed by the change image 33 generated by the change image generation unit 524 and information displayed by the fixed images 32 generated by the fixed image generation unit 527 may be associated with each other (FIG. 5) in the fourth embodiment.

Although a configuration has been described in the fourth embodiment described above in which one fixed image generation unit 527 is attached to each of both side portions of the concave mirror 526, the present invention is not limited thereto. For example, a plurality of fixed image generation units 527 may be attached to both side portions of the concave mirror 526 in parallel. For example, the concave mirror 526 may be attached to an upper side and/or a lower side of the concave mirror 526 instead of both side portions of the concave mirror 526.

For example, when two fixed image generation units 527 are attached to both sides of the concave mirror 526 in parallel, the virtual image object I may be displayed as follows. For example, the fixed image generation unit 527 sequentially turns on the light sources of the fixed image generation units 527 when generating the fixed images 32 shown in FIG. 5. The change image generation unit 524 generates the change image 33 in association with the turning on of the light sources by the fixed image generation unit 527. As a result, the virtual image object I is turned on and displayed in such a manner that, for example, the mountain parenthesis patterns move in order from the left and right ends toward the center as shown in FIG. 5.

As described above, the HUD 520 according to the fourth embodiment includes the change image generation unit 524 configured to emit light for generating the change image 31 that changes in accordance with a situation of the vehicle 1 among the virtual image object I (an example of a predetermined image), the concave mirror 526 (an example of a reflection unit) that reflects the light emitted by the change image generation unit 524 so as to radiate the light to the windshield 18, and the fixed image generation unit 527 that generates the fixed images 32 that are fixed regardless of the situation of the vehicle 1 among the virtual image object I. The fixed image generation unit 527 includes the light source 501, the optical member 502 that transmits or reflects light emitted from the light source 501, and the shield member 503 that is provided at a side opposite to the light source 501 across the optical member 502 and transmits the light of the light source 501 corresponding to a shape of the fixed image 32. According to this configuration, the virtual image object I can be formed by adding the fixed images 32 generated by the fixed image generation unit 527 to the change image 31 generated by the change image generation unit 524. Therefore, a display range of the virtual image object I (an example of a predetermined image) can be expanded without increasing a size of the high-cost change image generation unit 524.

The fixed image generation unit 527 includes the light source 501, the optical member 502, and the shield member 503, and is attached to the concave mirror 526. As a result, the fixed image generation unit 527 can be provided with a simple configuration, and the costs can be reduced.

In addition, since the fixed images 32 can be generated by providing the notch 514 in the shield member 503, the costs of the fixed image generation unit 527 can be further reduced.

According to the HUD 520, since the fixed images 32 can be generated by sequentially turning on the plurality of light sources arranged in parallel, the fixed images 32 having a good appearance can be displayed as the virtual image object I. Further, the virtual image object I having a better appearance can be obtained by combining the fixed images 32 with the change image 33.

### Second Modification

FIG. 14 is a schematic diagram showing a configuration of an HUD 620 according to a second modification.

As shown in FIG. 14, the HUD 620 according to the second modification includes the HUD main body 521 and the combiner 19. The change light emitted from the change image generation unit 524 and reflected by the concave mirror 526 and the fixed light emitted from the fixed image generation unit 527 are radiated to the combiner 19 instead of the windshield 18. Accordingly, a part of the light radiated from the HUD main body 521 to the combiner 19 is reflected toward the viewpoint E of an occupant in a similar manner to the case where light is radiated to the windshield 18. As a result, the occupant can recognize the emitted light (a predetermined image) from the HUD main body 521 as the virtual image object I formed at a predetermined distance in front of the combiner 19 (and the windshield 18).

In the case where the HUD 620 includes the combiner 19 as described above, the same effects as those of the HUD 520 described above can be achieved.

Although embodiments of the present invention have been described above, it is needless to say that the technical scope of the present invention should not be interpreted as being limited to the description of the embodiments. It is to be understood by those skilled in the art that the present embodiment is merely an example and various modifications may be made within the scope of the invention described in the claims. The technical scope of the present invention should be determined based on the scope of the inventions described in the claims and an equivalent scope thereof.

In the embodiments described above, the vehicle driving mode has been described as including the fully automatic driving mode, the advanced driving support mode, the driving support mode, and the manual driving mode, but the vehicle driving mode should not be limited to these four modes. The vehicle driving mode may include at least one of these four modes. For example, only one vehicle driving mode may be performed.

Further, a classification and display form of the vehicle driving mode may be appropriately changed according to laws or regulations related to automatic driving in each country. Similarly, definitions of the “fully automatic driving mode”, the “advanced driving support mode”, and the “driving support mode” described in the description of the present embodiments are merely examples, and the definitions may be appropriately changed according to the laws and the regulations related to the automatic driving in each country.

The present application is based on Japanese Patent Application NO. 2019-183648 filed on Oct. 4, 2019, Japanese Patent Application NO. 2019-183649 filed on Oct. 4, 2019, and Japanese Patent Application NO. 2019-212305 filed on Nov. 25, 2019, the contents of which are incorporated herein by reference.

1. A head-up display that is provided in a vehicle and configured to display predetermined images toward an occupant of the vehicle, the head-up display comprising:
an image generation unit configured to emit light for generating the predetermined images; and
a reflection unit configured to reflect the light emitted by the image generation unit so as to radiate the light to a windshield or a combiner,
wherein the image generation unit includes
a change image generation unit configured to generate a change image that changes in accordance with a situation of the vehicle among the predetermined images, and
a fixed image generation unit configured to generate fixed images that are fixed regardless of the situation among the predetermined images.

2. The head-up display according to claim 1,
wherein a distance from the windshield or the combiner to the change image is substantially the same as a distance from the windshield or the combiner to the fixed image, and the fixed images are respectively disposed at left and right sides of the change image.

3. The head-up display according to claim 1,
wherein an optical path length of the light between a surface of the change image generation unit for generating the change image and the reflection unit is different from an optical path length of the light between a surface of the fixed image generation unit for generating the fixed images and the reflection unit.

4. The head-up display according to claim 1,
wherein the fixed image generation unit includes
a light source,
an optical member that transmits or reflects light emitted from the light source, and
a shield member that is provided closer to the reflection unit than the optical member and transmits the light corresponding to a shape of the fixed images.

5. The head-up display according to claim 4,
wherein a plurality of the light sources are arranged in parallel, and
wherein the plurality of light sources are individually turned on and off when the fixed images are generated.

6. A head-up display that is provided in a vehicle and configured to display predetermined images toward an occupant of the vehicle, the head-up display comprising:
a change image generation unit configured to emit light for generating a change image that changes in accordance with a situation of the vehicle among the predetermined images;
a reflection unit configured to reflect the light emitted by the change image generation unit so as to radiate the light to a windshield or a combiner; and
a fixed image generation unit configured to generate fixed images that are fixed regardless of the situation among the predetermined images,
wherein the fixed image generation unit includes:
a light source,
an optical member that transmits or reflects light emitted from the light source, and
a shield member that is provided at a side opposite to the light source across the optical member and transmits the light in accordance with a shape of the fixed images.

7. The head-up display according to claim 6,
wherein the fixed image generation unit is attached to the reflection unit.

8. The head-up display according to claim 6,
wherein the fixed images are disposed at left and right sides of the change image when viewed from the occupant.

9. The head-up display according to claim 6,
wherein a plurality of the light sources are arranged in parallel, and
wherein the plurality of light sources are sequentially turned on when the fixed images are generated.

10. The head-up display according to claim 1,
wherein information displayed by the change image and information displayed by the fixed images are associated with each other.
